(19) United States
(12) Patent Application Publication
(10) Pub. No.: US 2021/0012327 A1
(43) Pub. Date: Jan. 14, 2021

(54) SYSTEM AND PLATFORM FOR VIRTUAL RESOURCE MANAGEMENT

(71) Applicant: Bank of America Corporation, Charlotte, NC (US)

(72) Inventor: Jayachandra Varma, Irving, TX (US)

(73) Assignee: Bank of America Corporation, Charlotte, NC (US)

(21) Appl. No.: 16/510,515

(22) Filed: Jul. 12, 2019

(51) Int. Cl. G06Q 20/36; G06Q 20/38; G06Q 20/40

(52) U.S. Cl. CPC G06Q 20/3678; G06Q 20/3672; G06Q 20/405; G06Q 20/381

(57) ABSTRACT

Embodiments of the present invention provide a system and platform for virtual resource management. The system may receive, from a user, an amount of resources in a medium of exchange that is foreign to the user. The system stores the received resources and associates them with a virtual account without converting or exchanging the resources for a local medium of exchange. The system then monitors information associated with the user to determine when a triggering event associated with the received resources is occurring or has occurred. In response to determining that the triggering event is occurring or has occurred, the system automatically executes a triggering action associated with the received resources.

### BACKGROUND

The management of resources that are in a medium of exchange that is foreign to a common, typical, or local medium of exchange for a user can be difficult to accomplish. A user could exchange held resources into a local medium of exchange, but this process typically involves a loss in value of the resources during the exchange process. However, keeping up with physical resources in a medium of exchange that is not easily usable unless in a foreign geographic region can be a difficult task. Therefore, a need exists to allow a user to manage its resources that are in foreign mediums of exchange without requiring the user to lose significant value on the resources through unnecessary resource conversions.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, platform, computer program product and/or other devices) and methods for providing virtual resource management. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving, from a user, a deposited amount of resources in a foreign medium of exchange that is not a local medium of exchange of an account of the user. The system may the store the deposited amount of resources without converting it to the local medium of exchange of the account of the user, and generate a virtual account for the user configured to represent amounts of resources in the medium of exchange that is not the local medium of exchange of the account of the user. Next, the system can populate the virtual account with the deposited amount of resources. The system may then monitor account information associated with the virtual account of the user and an occurrence of a triggering event. The system may then receive an indication that the triggering event has occurred. In response to receiving the indication that the triggering event has occurred, the system will automatically perform a triggering action.

In some embodiments of the system, the triggering event comprises a determination that the user is in a geographic location associated with the foreign medium of exchange. In such embodiments, the triggering action may comprise a step of automatically modifying the account of the user to execute requested transactions in the foreign medium of exchange for a predetermined period of time. Subsequently, the system may receive a request from the user to execute a transaction and, in response, execute the transaction using the foreign medium of exchange. The system may subsequently determine that the user is no longer in the geographic location associated with the foreign medium of exchange. In response to determining that the user is no longer in the geographic location associated with the foreign medium of exchange, the system may modify the account of the user to execute requested transactions in the local medium of exchange.

The triggering event may, in some embodiments, comprise a determination that the user is requesting a withdrawal of a portion of a current amount of resources in the virtual account, wherein the user is determined to be located in a geographic location associated with a second foreign medium of exchange that is different from the local medium of exchange and the foreign medium of exchange. In such embodiments, the triggering action comprises a step of automatically converting the portion of the current amount of resources in the virtual account into an amount in the second foreign medium of exchange at a most-favorable exchange rate, and automatically dispensing the converted amount in the second foreign medium of exchange.

Additionally or alternatively, the triggering event may comprise a request for withdrawal of a portion of a current amount of funds in the virtual account. In such embodiments, the triggering action may comprise a step of automatically dispensing the portion of the current amount of funds in the virtual account in the foreign medium of exchange.

In some embodiments, the triggering event comprises a determination that an exchange rate for the deposited resources to convert to the local medium of exchange meets a predetermined threshold conversion rate. In such embodiments, the triggering action may comprise the steps of automatically converting the amount of funds in the virtual account into the local medium of exchange, and populating the resulting converted amount of funds in the account of the user that is in the local medium of exchange.

Additionally or alternatively, the triggering event may comprise a request from a computing device of the user to transfer a portion of a current amount of resources in the virtual account to an account of a second user. In such embodiments, the triggering action may comprise a step of automatically transferring the portion of the current amount of resources from the virtual account of the user to the account of the second user, wherein the portion of the current amount of resources remains in the foreign medium of exchange.

The system may, in some embodiments, be configured to invest the deposited resources, and permit the amount of funds in the virtual account to grow over time based on a predetermined interest rate.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for virtual resource management, in accordance with an embodiment of the invention;

FIG. 2 provides a block diagram illustrating the managing entity system of FIG. 1, in accordance with an embodiment of the invention;

FIG. 3 provides a block diagram illustrating the virtual resource management system of FIG. 1, in accordance with an embodiment of the invention;

FIG. 4 provides a block diagram illustrating the computing device system of FIG. 1, in accordance with an embodiment of the invention; and

FIG. 5 provides a flowchart illustrating a process for virtual resource management, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

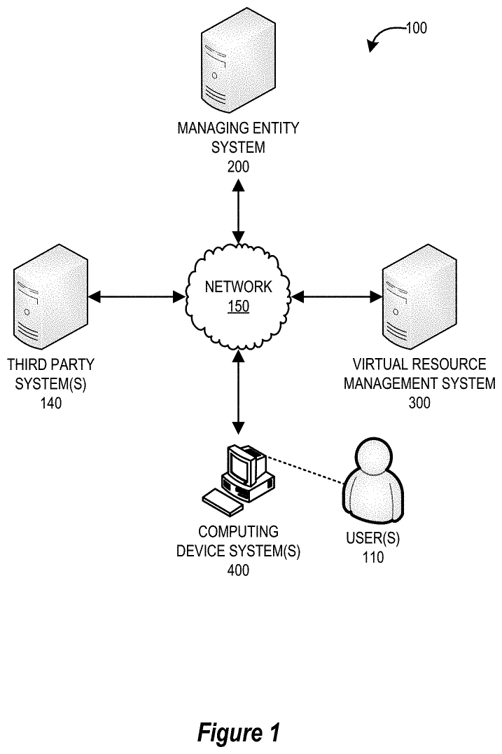

FIG. 1 provides a block diagram illustrating a system environment 100 for virtual resource management, in accordance with an embodiment of the invention. As illustrated in FIG. 1, the environment 100 includes a managing entity system 200, a virtual resource management system 300, one or more computing device systems 400, and one or more third party systems 140. One or more users 110 may be included in the system environment 100. In some embodiments, the user(s) 110 of the system environment 100 may be a customer of a managing entity that owns or otherwise operates the managing entity system 200, and/or the virtual resource management system 300. Multiple users 110 may be included in the system environment 100, where each user 110 is associated with one or more computing device systems 400, and uses such computing device systems 400 to interface with and communicate information with the other systems of the system environment 100.

The managing entity system 200, the virtual resource management system 300, the one or more computing device systems 400, and/or the third party system 140 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

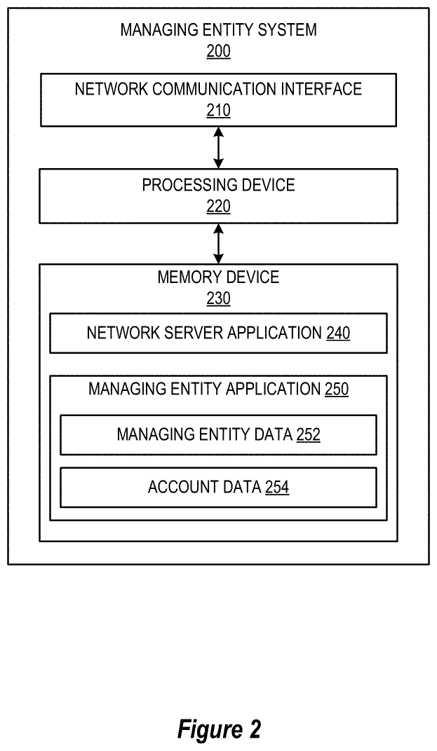

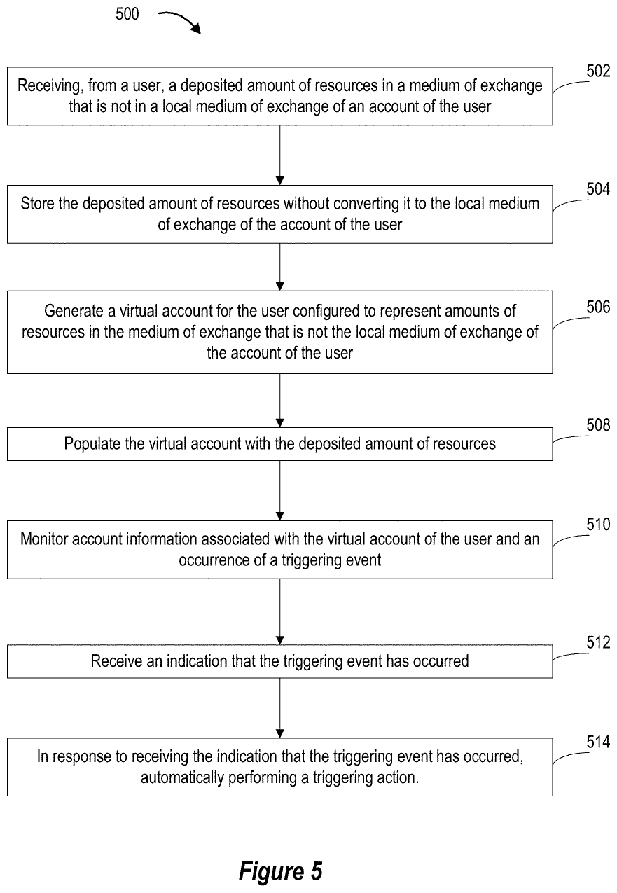

The managing entity system 200 may be a system owned or otherwise controlled by a managing entity to perform one or more process steps described herein. In some embodiments, the managing entity is a financial institution. In general, the managing entity system 200 is configured to communicate information or instructions with the virtual resource management system 300, the one or more computing device systems 400, and/or the third party system 140 across the network 150. For example, the managing entity system 200 may receive a deposit of resources in a particular currency from the user 110, and the system 200 may transit instructions to the virtual resource management system 300 to cause it to generate a virtual account associated with the user 110 and/or to populate the virtual account associated with the user 110 with the amount of the deposited resources. The managing entity system 200 may additionally or alternatively be configured to actively analyze a location of a computing device system 400 associated with a particular user 110 to determine when the user 110 likely is located within a particular geographic region (e.g., a region associated with a particular currency). Of course, the managing entity system 200 may be configured to perform (or instruct other systems to perform) one or more other process steps described herein (e.g., the process step blocks 502-514 described in FIG. 5). In some embodiments, the managing entity system 200 controls, instructs, or otherwise manages the virtual resource management system 300 and one or more of the one or more computing device systems 400 of the system environment 100. The managing entity system 200 is described in more detail with respect to FIG. 2.

The virtual resource management system 300 may be a system owned or controlled by the managing entity and/or a third party that specializes in managing accounts, generating virtual accounts, executing deposits, withdrawals, and transfers of resources, executing exchanges or other conversions of resources from one currency or medium of exchange to another, and/or the like. In some embodiments, at least a portion of the virtual resource management system 300 is a component of the managing entity system 200. The virtual resource management system 300 may control, instruct, or otherwise manage one or more of the computing device systems 400 (e.g., an automated teller machine) associated with the system environment 100.

In general, the virtual resource management system 300 is configured to communicate information or instructions with the managing entity system 200, the one or more computing device systems 400, and/or the third party system(s) 140 across the network 150. For example, the virtual resource management system 300 may receive a prompt, a transmitted signal, or another indication from a computing device system 400 associated with the user 110 that instructs or causes the virtual resource management system 300 to convert a portion of the resources stored in the virtual account into a different currency. The virtual resource management system 300 may additionally or alternatively be configured to receive, from a computing device system 400 (e.g., a point of sale device), a transaction request associated with the user 110, along with a location of such transaction and/or a currency of the transaction. In such embodiments, the virtual resource management system 300 may be configured to convert an appropriate amount of resources currently associated with a virtual account of the user into the currency of the transaction and then execute the transaction on behalf of the user 110.

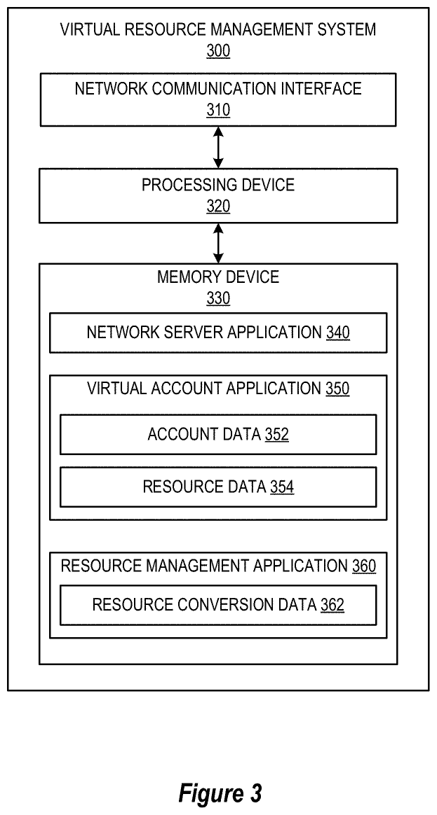

Of course, the virtual resource management system 300 may be configured to perform (or instruct other systems to perform) one or more other process steps described herein. The virtual resource management system 300 is described in more detail with respect to FIG. 3.

The computing device system 400 may be a system owned or controlled by the managing entity and/or a third party that specializes in providing user interfaces that permit one or more users (e.g., the user 110) to communicate with other systems of the system environment 100. In general, the computing device system 400 is configured to communicate information or instructions with the managing entity system 200, the virtual resource management system 300, and/or the third party system(s) 140 across the network 150. For example, the computing device system 400 may receive a user input from the user 110 of a deposit of resources that are in a particular currency. In such embodiments, the computing device system (e.g., an automated teller machine) may accept the resources, identify an amount of the resources, and transmit the identified amount of resources to the virtual resource management system 300, such that the virtual resource management system 300 can associate that amount of resources with a virtual account for the same currency. Additionally or alternatively, a computing device system 400 may be configured to receive an indication from a user 110 that the user 110 would like to convert a portion of resources from one currency to another currency if an associated conversion rate reaches a particular value. Once the computing device system 400 receives this indication, it can transmit this information as a triggering event for the user 110 to the virtual resource management system 300, which in turn will monitor the relevant information for determining when the triggering event occurs.

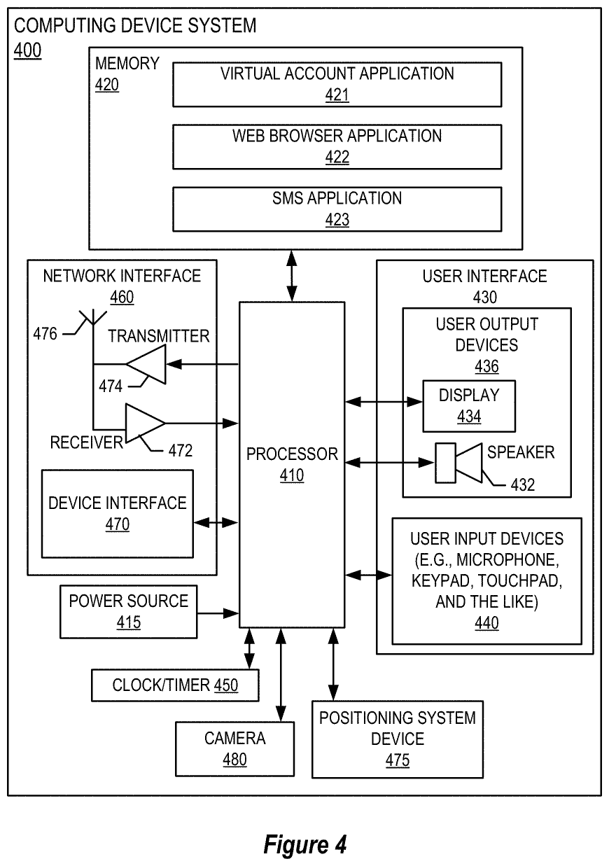

Of course, the computing device system 400 may be configured to perform (or instruct other systems to perform) one or more other process steps described herein. The computing device system 400 is described in more detail with respect to FIG. 4.

The system environment 100 may comprise one or more additional systems (i.e., third party systems 140) that comprise a network communication interface, a processing device, and one or more memory devices, where the processing devices are configured to perform certain actions with the memory devices and communicate these actions to the rest of the network 150 through the network communication interface. For example, a third party system 140 may comprise a financial institution that is different from a financial institution that manages the managing entity system 200, but where the two institutions have a relationship that allows a user 110 to utilize resources and computing device systems (e.g., automated teller machines) of both institutions such that information about a virtual account of the user is available in geographic locations that are outside of where the financial institution associated with the managing entity system 200 typically operates (e.g., through a transmission of information from the managing entity system 200 and/or the virtual resource management system 300).

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution, while in other embodiments, the managing entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a managing entity application 250 which includes managing entity data 252 and account data 254, and other computer-executable instructions or other data. The computer-executable program code of the network server application 240, and/or the managing entity application 250 may instruct the processing device 220 to perform certain logic, data-processing, and data-storing functions of the managing entity system 200 described herein, as well as communication functions of the managing entity system 200.

In one embodiment, the managing entity application 250 includes managing entity data 252 and account data 254. The managing entity data 252 may comprise information about which users (e.g., the users 110) are associated with the managing entity, information about those users (e.g., computing devices associated with the users 110, log-in and authorization credentials for the users 110), and the like. The account data 254 may comprise information about which accounts held by the financial institution that owns or controls the managing entity system are associated with which users 110, information about account balances, transfer activity, historical account information, and the like.

The network server application 240 and the managing entity application 250 are configured to invoke or use the managing entity data 252, the account data 254, and the like when communicating through the network communication interface 210 with the virtual resource management system 300, the one or more computing device systems 400, and/or the third party system(s) 140.

FIG. 3 provides a block diagram illustrating the virtual resource management system 300, in greater detail, in accordance with embodiments of the invention. As illustrated in FIG. 3, in one embodiment of the invention, the virtual resource management system 300 includes one or more processing devices 320 operatively coupled to a network communication interface 310 and a memory device 330. In certain embodiments, the virtual resource management system 300 is operated by a first entity, such as a financial institution, while in other embodiments, the virtual resource management system 300 is operated by an entity other than a financial institution.

It should be understood that the memory device 330 may include one or more databases or other data structures/repositories. The memory device 330 also includes computer-executable program code that instructs the processing device 320 to operate the network communication interface 310 to perform certain communication functions of the virtual resource management system 300 described herein. For example, in one embodiment of the virtual resource management system 300, the memory device 330 includes, but is not limited to, a network server application 340, a virtual account application 350 which includes account data 352 and resource data 354, a resource management application 360 which includes resource conversion data 362, and other computer-executable instructions or other data. The computer-executable program code of the network server application 340, the virtual account application 350, and/or the resource management application 360 may instruct the processing device 320 to perform certain logic, data-processing, and data-storing functions of the virtual resource management system 300 described herein, as well as communication functions of the virtual resource management system 300.

In one embodiment, the virtual account application 350 includes account data 352 and resource data 354. The account data 352 may comprise information about an amount of resources in a particular currency that are available to an associated user (e.g., the user 110) at any particular time, as well as historically, within a virtual account that is managed by the virtual resource management system 300. This account data 352 may also include information about interest rates, withdrawal capabilities, deposit capabilities, user authentication information, and the like, that are associated with particular virtual accounts of certain users.

The resource data 354 may include information about the actual resources that are linked with, associated with, held for the association with, or otherwise tied to an amount of virtual resources that are represented in a virtual account of a particular user.

In one embodiment, the resource management application 360 includes resource conversion data 362. This resource conversion data 362 may include information about currency exchange rates, currency exchange fees, currency comparison values (i.e., actual equivalent values between currencies, as opposed to values set by an exchange market), currency exchange rate limits established by a user for a particular virtual account, and/or the like.

The network server application 340, the virtual account application 350, and the resource management application 360 are configured to invoke or use the account data 352, the resource data 354, the resource conversion data 362, and the like when communicating through the network communication interface 310 with the managing entity system 200, the one or more computing device system(s) 400, and/or the third party system(s) 140.

FIG. 4 provides a block diagram illustrating a computing device system 400 of FIG. 1 in more detail, in accordance with embodiments of the invention. In one embodiment of the invention, the computing device system 400 is a mobile telephone. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices. The positioning system device 475 may play a crucial role in transmitting location information associated with the computing device system 400 for determining when the computing device system 400 is in at or is in close proximity to certain geographic locations that are associated with particular currencies.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422 and/or a virtual account application 421 (or any other application provided by the managing entity system 200). These applications also typically instructions to a graphical user interface (GUI) on the display 430 that allows the user 110 to interact with the computing device system 400, the managing entity system 200, and/or other devices or systems. In one embodiment of the invention, when the user 110 decides to enroll in a virtual account application 421 program, the user 110 downloads, is assigned, or otherwise obtains the virtual account application 421 from the managing entity system 200, or from a distinct application server (e.g., from the virtual resource management system 300). In other embodiments of the invention, the user 110 interacts with the managing entity system 200 or the resource accumulation system 400 via the web browser application 422 in addition to, or instead of, the virtual account application 421.

The virtual account application 421 may be configured to receive input from, and/or provide information to, an associated user 110, and to transmit information to and/or receive information from the other systems of the system environment 100. For example, the virtual account application 421 may cause the display 334 to present the user 110 with information about available triggering events associated with a virtual account owned by the user 110, whereby the user 110 is able to select (e.g., by using a user input device 440) one or more of the presented available triggering events. In such embodiments, the virtual account application 421 may receive this selection and transmit the selection to the virtual resource management system 300.

The memory 420 of the computing device system 400 may comprise a Short Message Service (SMS) application 423 configured to send, receive, and store data, information, communications, alerts, and the like via the wireless telephone network 152.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

Referring now to FIG. 5, a flowchart is provided to illustrate one embodiment of a process 500 for virtual resource management, in accordance with embodiments of the invention. In some embodiments, the process 500 may include block 502, where the system receives, from a user, a deposited amount of resources (e.g., funds, cash, financial instrument, or the like) in a medium of exchange (e.g., a particular currency) that is not in a local medium of exchange of an account of the user. This deposit may be an amount of funds in a foreign currency, where the normal financial account of the user at a financial institution associated with a managing entity system (e.g., the managing entity system 200).

In some embodiments, the process 500 includes block 504, where the system stores the deposited amount of resources without converting it to the local currency of the account of the user. Even though the financial institution would not otherwise take the foreign currency without converting the foreign currency into the local currency, this system is configured to separately store the foreign currency in a manner that allows the associated financial institution to manage the received amount foreign currency (and possibly to invest, transfer, or otherwise utilize the foreign currency).

Additionally, in some embodiments, the process 500 includes block 506, where the system generates a virtual account for the user configured to represent amounts of resources in the currency that is not the local currency of the account of the user. This virtual account may be accessed by a financial institution application stored on a computing device of the user, a virtual account application of the user (e.g., the virtual account application 421), an online account of the user, or the like. The virtual account provides a representation of a current amount of resources in the foreign currency that are being held by the financial institution, or by a related or associated financial institution (e.g., a separate financial institution that is part of a common consortium of financial institutions, or a separate financial institution that has a contractual or other relationship with the managing entity financial institution such that they manage or otherwise support the virtual account of the user). In some embodiments, distinct virtual accounts are opened and held for use for the user for each different type of currency, or foreign currency, that the user deposits. In other embodiments, at least two different types of currency, or foreign currency, are stored in a common virtual account, where the virtual account provides current balances for each type of currency.

The process 500 may also include block 508, where the system populates the virtual account with the deposited amount of resources. By populating the virtual account, the system may associate the deposited resources (i.e., in the foreign currency) with the virtual account and adjust the virtual account to show or otherwise be associated with the deposited amount of resources of the foreign currency. The system may monitor the virtual account, allow for transactions into and out of the virtual account, and the like, all while maintaining an accurate representation of a current amount of resources that are currently associated with the virtual account. Of course, if physical resources were deposited, the system may store these physical resources in a separate location and keep track of the amount of the resources that are attributable to, and owned by, the user.

Because the system has stored the deposited amount of resources, the system may be configured to invest the deposited resources (e.g., by transmitting the deposited amount of resources to an investment account, by transmitting a portion of the deposited amount of resources to an investment account, or the like). In such embodiments, the system may permit the amount of funds that is associated with the virtual account to grow over time based on a predetermined interest rate (e.g., an interest rate set by the managing entity of the managing entity system, an interest rate that is based on the currency of the deposited funds, and/or the like).

In some embodiments, the process 500 includes block 510, where the system monitors account information associated with the virtual account of the user and an occurrence of a triggering event. The triggering event may be any one factor, or a combination of factors, that are associated with the user, the virtual account, the normal account of the user, an account one or more other users that are associated with the user, one or more computing devices associated with the user, geographic information about the user, time information for the user, calendar information for the user, or the like. As will be described in more detail below, each triggering event is associated with one or more particular triggering actions that are automatically executed by the system in response to a determination that the triggering event has occurred.

One example of a triggering event is a determination that the user is in a geographic location associated with the foreign medium of exchange (e.g., currency). Another example of a triggering event is a determination that the user is requesting a withdrawal of a portion of a then-current of resources in the virtual account, while the user is also determined to be located within a geographic location that is associated with a different (e.g., a “second”) medium of exchange or currency.

A request (e.g., from a computing device of the user) for a withdrawal of at least a portion of the then-current amount of funds in the virtual account may, by itself or with one or more other factors, represent a triggering event for the system.

In some embodiments, a triggering event may comprise a determination that an exchange rate for the medium of exchange (e.g., currency) meets or exceeds a predetermined (e.g., set by the user) threshold conversion rate. For example, the user may request to convert at least a portion of the resources from its current currency into the local currency only when the conversion rate is at or above a certain favorable rate. In another example, the user may request to convert at least a portion of the resources from its current currency into the local currency only when the rate is at or below a certain unfavorable rate (e.g., to accept a known decrease in value of the resources without allowing the conversion rate to continue to drop).

Furthermore, the triggering event may, in some embodiments, comprise a request from a computing device of the user to transfer at least a portion of the current amount of resources in the virtual account to an account of a second user. This request can be to convert the resources into a different currency before transmitting, to keep the resources in their current currency, or a combination of the two.

Additionally, in some embodiments, the process 500 includes block 512, where the system receives an indication that the triggering event has occurred. Receiving an indication that the triggering event has occurred may comprise a determination that the triggering event is occurring, has occurred, is imminent, or the like. It may also comprise actually receiving a signal, a request, a prompt, or the like from a computing device associated with the user (e.g., a mobile device of the user, an automated teller machine, an electronic kiosk, a computing device of a financial institution teller, or the like).

In embodiments where the triggering event comprises a determination that the user is in a geographic location associated with the foreign currency, the step of receiving an indication that the triggering event has occurred may be conducted by detecting a presence of a GPS component of a computing device of the user (e.g., the positioning system device 475) within a geographic region that is known by the system to be associated with the foreign currency (i.e., the currency that the resources are currently comprised of). Additionally or alternatively, this triggering event may be determined by receiving an indication that the user has entered credentials at an electronic kiosk, an automated teller machine, or some other computing device system that is known to be located in a geographic region associated with the foreign currency.

In embodiments where the triggering event comprises a determination that the user is requesting a withdrawal of at least some resources, but the user is in a geographic location that is associated with a different (e.g., a “second”) foreign currency, the system may determine that the triggering event is occurring by receiving the request from the user and either actively detecting a location of a computing device associated with the user (e.g, a mobile computing device of the user, a mobile telephone of the user, an electronic kiosk or automated teller machine that the user has accessed and provided identifying information) that is associated with the different, or second, foreign currency.

In embodiments where the triggering event comprises a request for withdrawal of a portion of a current amount of funds in the virtual account, the system may determine the occurrence of the triggering event by receiving a prompt, signal, set of instructions, or the like from a computing device associated with the user that requests such a withdrawal.

In embodiments where the triggering event comprises a determination that an exchange rate for the deposited resources to convert to the local currency meets a predetermined threshold conversion rate, the system may make this determination by determining from an active analysis of conversion rate (or from a passive reception of a data feed of current conversion rates) that the current conversion rate of the current currency (i.e., the foreign currency) to the local currency is at the triggering value or ratio.

In embodiments where the triggering event comprises request from a computing device of the user to transfer a portion of a current amount of resources in the virtual account to an account of a second user, the system's determination that the triggering event is occurring may simply be the reception of such a request (e.g., via a signal transmitted from the computing device of the user that instructs the system to execute the transfer).

Finally, the process 500 may continue to block 514, where, in response to receiving the indication that the triggering event has occurred, the system automatically performs a triggering action.

In embodiments where the triggering event is a determination that the user is in a geographic location associated with the foreign currency, the triggering action may comprise a step of automatically modifying the account of the user to execute any requested transactions in the foreign currency for at least a predetermined period of time (e.g., an hour, a day, a week, a month, a year, or the like). In such embodiments, the system may subsequently receive a request from the user to execute the transaction, and the system will then execute such transaction(s) using the foreign medium of exchange/currency. In some embodiments, the predetermined period of time during which the system will execute requested transactions of the user by using the foreign currency, may be for however long the user is determined to be located in that general location (e.g., within a country that uses that foreign currency). Additionally or alternatively, the system may monitor a location of the user and determine that the user is no longer in the geographic location associated with the foreign currency. In response to this determination, the system may modify the account (e.g., the normal account of the user associated with the local currency, and/or the virtual account of the user) to execute any subsequently-requested transactions in the local currency.

In embodiments where the triggering event comprises a determination that the user is requesting a withdrawal of a portion of the a current amount of resources in the virtual account, and where the user is determined to be in a geographic location that is associated with a different, or second, foreign currency that is different from the local currency and the foreign currency of the virtual application, a first triggering action step may be for the system to automatically convert the portion of the current amount of resources in the virtual account into an amount in the second foreign currency at a most-favorable exchange rate. A second triggering action in such embodiments may comprise automatically dispensing the converted amount to the user, in the second foreign currency. In this way, a user is able to maintain a deposited amount of resources in a particular currency (including opportunities to grow interest on the deposited amount) after returning from a trip to a country with a different (i.e., foreign) method of exchange (i.e., currency), and can then withdraw resources in a currency or method of exchange of a different region without having to convert the resources from the first foreign currency into the local currency and then subsequently converting the resources from the local currency to the second foreign currency. Converting resources from one currency to another typically involves a percentage-based loss in value for the user converting the resources, so only executing a single resource exchange reduces a total amount of loss in value for the amount of resources that the user is associated with.

When the triggering event comprises a request for withdrawal of a portion of a current amount of funds in the virtual account, the triggering action for the system may be a step of automatically dispensing the portion of the current amount of funds in the virtual account in the foreign currency. For example, the user may be re-visiting a geographic region that is associated with the currency of the user's virtual account, and therefore the user wishes to extract physical resources (e.g., cash) in that foreign currency either before the trip or while on the trip. In this way, the user is able to receive physical resources in the appropriate currency without having to exchange the resources into a local currency and then back to the foreign currency. Furthermore, the user does not have to personally store and manage physical resources in the foreign currency for the period of time between an initial trip to the current trip because the user has deposited the resources with a financial institution associated with the system.

In embodiments where the triggering event comprises a determination that an exchange rate for the deposited resources to convert to the local currency meets a predetermined threshold conversion rate, the triggering action may comprise a first step of automatically converting the then-current amount of funds in the virtual account into the local currency. Additionally, the triggering action may comprise a second step of populating the resulting converted amount of funds in the account of the user that is in the local currency (i.e., the normal, non-virtual account of the user). In this way, the user is able to wait for a favorable exchange rate to be available before converting the resources from the foreign currency into the local currency. Additionally or alternatively, when an exchange rate of the triggering event is a lower limit to the exchange rate, the user is also able to ensure that the resources will be exchanged at that lower limit to the exchange rate, and not at a lower exchange rate, in the event the exchange rate drops.

Furthermore, in embodiments where the triggering event comprises a request from a computing device of the user (i.e., a first user) to transfer a portion of a current amount of resources in the virtual account to an account of a second user, the triggering action may comprise a step of automatically transferring the portion of the current amount of resources from the virtual account of the user to the account of the second user, where the portion of the current amount of the resources remains in the foreign currency. As with the triggering action of a withdrawal of physical resources for the user, this transfer of resources in the foreign currency takes advantage of a fact that the currency is not exchanged back to local currency, transferred to the second user, and then exchanged back into the foreign currency; thereby eliminating an unnecessary loss in value for the amount of resources that are transferred to the second user and/or that are usable by the second user.

In some embodiments, the transfer of the foreign resources from the first user to the second user may comprise an exchange, where the second user transfers an amount of resources in the local currency to the first user. The equivalent value of the resources may be made at an agreed-upon amount or rate between the two users, or may be based on one or more current exchange rates between the foreign and the local currency. The users may exchange the resources at an exchange rate that is more favorable to the users than what either would typically receive when exchanging the resources. For example, if a typical exchange rate from the foreign currency to the local currency is 1.1345, but the typical exchange rate from the local currency to the foreign currency is 0.87625, the system may determine a middle ground based on these two exchange rates that is representative of an actual equivalence value that does not take into account any loss of value that would be attributable to the conversion of the resources (e.g., 1.1423 from the foreign currency to the local currency and 1/1.1423 from the local currency to the foreign currency). In this way, neither user loses value in their amount of resources due to an exchange fee or built-in exchange fee that is part of an offered exchange rate. In some embodiments, the system may provide a portal that allows multiple users to exchange different currencies directly with each other, from virtual or other accounts, in this manner such that the exchange rates remain favorable between the users.

Of course, the system may include multiple triggering events and associated triggering actions (e.g., as set or requested by the user, via an account application like the virtual account application 421), where each triggering event may or may not occur. For example, the user may set a lower limit and an upper limit on the exchange rates from the foreign currency to the local currency, with triggering actions to exchange the resources in the virtual account if either limit is hit. In the same embodiment, the user may set a triggering event of a determination that the user is in a geographic location associated with a second foreign currency and that the user has requested a transaction, where the triggering event is that the system will convert the resources from the foreign currency to the second foreign currency and execute the transaction in the second foreign currency. As such, these triggering events and triggering actions are not meant to be exclusive events and actions, but instead can be used in combination or in the alternative to each other.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for virtual resource management, the system comprising:
a memory device; and
a processing device operatively coupled to the memory device, wherein the processing device is configured to execute computer-readable program code to:
receive, from a user, a deposited amount of resources in a foreign medium of exchange that is not a local medium of exchange of an account of the user;
store the deposited amount of resources without converting it to the local medium of exchange of the account of the user;
generate a virtual account for the user configured to represent amounts of resources in the medium of exchange that is not the local medium of exchange of the account of the user;
populate the virtual account with the deposited amount of resources;
monitor account information associated with the virtual account of the user and an occurrence of a triggering event;
receive an indication that the triggering event has occurred; and
in response to receiving the indication that the triggering event has occurred, automatically perform a triggering action.

2. The system of claim 1, wherein:
the triggering event comprises a determination that the user is in a geographic location associated with the foreign medium of exchange;
the triggering action comprises automatically modifying the account of the user to execute requested transactions in the foreign medium of exchange for a predetermined period of time; and
the processing device is further configured to execute computer-readable program code to:
receive a request from the user to execute a transaction; and
execute the transaction using the foreign medium of exchange.

3. The system of claim 2, wherein the processing device is further configured to execute computer-readable program code to:
determine that the user is no longer in the geographic location associated with the foreign medium of exchange; and
in response to determining that the user is no longer in the geographic location associated with the foreign medium of exchange, modify the account of the user to execute requested transactions in the local medium of exchange.

4. The system of claim 1, wherein:
the triggering event comprises a determination that the user is requesting a withdrawal of a portion of a current amount of resources in the virtual account, wherein the user is determined to be located in a geographic location associated with a second foreign medium of exchange that is different from the local medium of exchange and the foreign medium of exchange; and
the triggering action comprises:
automatically converting the portion of the current amount of resources in the virtual account into an amount in the second foreign medium of exchange at a most-favorable exchange rate; and
automatically dispensing the converted amount in the second foreign medium of exchange.

5. The system of claim 1, wherein:
the triggering event comprises a request for withdrawal of a portion of a current amount of funds in the virtual account; and
the triggering action comprises automatically dispensing the portion of the current amount of funds in the virtual account in the foreign medium of exchange.

6. The system of claim 1, wherein:
the triggering event comprises a determination that an exchange rate for the deposited resources to convert to the local medium of exchange meets a predetermined threshold conversion rate; and
the triggering action comprises:
automatically converting the amount of funds in the virtual account into the local medium of exchange; and
populating the resulting converted amount of funds in the account of the user that is in the local medium of exchange.

7. The system of claim 1, wherein:
the triggering event comprises a request from a computing device of the user to transfer a portion of a current amount of resources in the virtual account to an account of a second user; and
the triggering action comprises automatically transferring the portion of the current amount of resources from the virtual account of the user to the account of the second user, wherein the portion of the current amount of resources remains in the foreign medium of exchange.

8. The system of claim 1, wherein the processing device is further configured to execute computer-readable program code to:
invest the deposited resources; and
permit the amount of funds in the virtual account to grow over time based on a predetermined interest rate.

9. A computer program product for virtual resource management, the computer program product comprising at least one non-transitory computer readable medium comprising computer readable instructions, the instructions comprising instructions for:
receiving, from a user, a deposited amount of resources in a foreign medium of exchange that is not a local medium of exchange of an account of the user;
storing the deposited amount of resources without converting it to the local medium of exchange of the account of the user;
generating a virtual account for the user configured to represent amounts of resources in the medium of exchange that is not the local medium of exchange of the account of the user;
populating the virtual account with the deposited amount of resources;
monitor account information associated with the virtual account of the user and an occurrence of a triggering event;
receiving an indication that the triggering event has occurred; and
in response to receiving the indication that the triggering event has occurred, automatically performing a triggering action.

10. The computer program product of claim 9, wherein:
the triggering event comprises a determination that the user is in a geographic location associated with the foreign medium of exchange;
the triggering action comprises automatically modifying the account of the user to execute requested transactions in the foreign medium of exchange for a predetermined period of time; and
the computer readable instructions further comprise instructions for:
receiving a request from the user to execute a transaction; and
executing the transaction using the foreign medium of exchange.

11. The computer program product of claim 10, wherein the computer readable instructions further comprise instructions for:
determining that the user is no longer in the geographic location associated with the foreign medium of exchange; and
in response to determining that the user is no longer in the geographic location associated with the foreign medium of exchange, modifying the account of the user to execute requested transactions in the local medium of exchange.

12. The computer program product of claim 9, wherein:
the triggering event comprises a determination that the user is requesting a withdrawal of a portion of a current amount of resources in the virtual account, wherein the user is determined to be located in a geographic location associated with a second foreign medium of exchange that is different from the local medium of exchange and the foreign medium of exchange; and
the triggering action comprises:
automatically converting the portion of the current amount of resources in the virtual account into an amount in the second foreign medium of exchange at a most-favorable exchange rate; and
automatically dispensing the converted amount in the second foreign medium of exchange.

13. The computer program product of claim 9, wherein:
the triggering event comprises a request for withdrawal of a portion of a current amount of funds in the virtual account; and
the triggering action comprises automatically dispensing the portion of the current amount of funds in the virtual account in the foreign medium of exchange.

14. The computer program product of claim 9, wherein:
the triggering event comprises a determination that an exchange rate for the deposited resources to convert to the local medium of exchange meets a predetermined threshold conversion rate; and
the triggering action comprises:
automatically converting the amount of funds in the virtual account into the local medium of exchange; and
populating the resulting converted amount of funds in the account of the user that is in the local medium of exchange.

15. The computer program product of claim 9, wherein:
the triggering event comprises a request from a computing device of the user to transfer a portion of a current amount of resources in the virtual account to an account of a second user; and
the triggering action comprises automatically transferring the portion of the current amount of resources from the virtual account of the user to the account of the second user, wherein the portion of the current amount of resources remains in the foreign medium of exchange.

16. The computer program product of claim 9, wherein the computer readable instructions further comprise instructions for:
investing the deposited resources; and
permitting the amount of funds in the virtual account to grow over time based on a predetermined interest rate.

17. A computer implemented method for virtual resource management, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a user, a deposited amount of resources in a foreign medium of exchange that is not a local medium of exchange of an account of the user;
storing the deposited amount of resources without converting it to the local medium of exchange of the account of the user;
generating a virtual account for the user configured to represent amounts of resources in the medium of exchange that is not the local medium of exchange of the account of the user;
populating the virtual account with the deposited amount of resources;
monitor account information associated with the virtual account of the user and an occurrence of a triggering event;
receiving an indication that the triggering event has occurred; and
in response to receiving the indication that the triggering event has occurred, automatically performing a triggering action.

18. The computer implemented method of claim 17, wherein:
the triggering event comprises a determination that the user is in a geographic location associated with the foreign medium of exchange;
the triggering action comprises automatically modifying the account of the user to execute requested transactions in the foreign medium of exchange for a predetermined period of time; and
the computer implemented method further comprising:
receiving a request from the user to execute a transaction; and
executing the transaction using the foreign medium of exchange.

19. The computer implemented method of claim 18, further comprising:
determining that the user is no longer in the geographic location associated with the foreign medium of exchange; and
in response to determining that the user is no longer in the geographic location associated with the foreign medium of exchange, modifying the account of the user to execute requested transactions in the local medium of exchange.

20. The computer implemented method of claim 17, wherein:
the triggering event comprises a determination that the user is requesting a withdrawal of a portion of a current amount of resources in the virtual account, wherein the user is determined to be located in a geographic location associated with a second foreign medium of exchange that is different from the local medium of exchange and the foreign medium of exchange; and
the triggering action comprises:
automatically converting the portion of the current amount of resources in the virtual account into an amount in the second foreign medium of exchange at a most-favorable exchange rate; and
automatically dispensing the converted amount in the second foreign medium of exchange.
